(19) United States
(12) Patent Application Publication
(10) Pub. No.: US 2023/0124968 A1
(43) Pub. Date: Apr. 20, 2023

(54) Method and System for Delivery Assignment and Routing

(71) Applicant: Roadie, Inc., Altanta, GA (US)

(72) Inventors: Stephen Greyson Daugherty, Peachtree City, GA (US); Garrett Mallory, Atlanta, GA (US)

(21) Appl. No.: 17/674,096

(22) Filed: Feb. 17, 2022

Related U.S. Application Data
(60) Provisional application No. 63/256,829, filed on Oct. 18, 2021.

(51) Int. Cl. G06Q 10/08; G06Q 10/04

(52) U.S. Cl. CPC G06Q 10/08355; G06Q 10/0834; G06Q 10/047

(57) ABSTRACT

Embodiments of the present systems and methods may provide techniques for assigning deliveries to drivers and for routing those deliveries that ensure delivery and encourage drivers to submit offers. For example, a method may comprise receiving information relating to delivery drivers' offers to deliver items in a consolidation of deliveries including at least one delivery, generating, for each delivery driver's offer, a score that indicates a desirability of that delivery driver's offer, generating, for each delivery driver's offer, a threshold time indicating a time to wait before accepting the delivery driver's offer, and matching delivery drivers with consolidations of deliveries based on maximizing a number of delivery tasks assigned to drivers and maximizing a sum of the desirability scores for the delivery drivers' offers.

### BACKGROUND

The present invention relates to techniques for assigning deliveries to drivers while ensuring on-time deliverability.

Dispatch-based delivery or passenger systems typically select one driver, or a small number of drivers, to offer a delivery or ride, and the driver or drivers may accept or refuse that delivery or ride. Bid-based delivery or passenger systems typically notify all, or a significant subset of, drivers, about all or many of the deliveries or rides that are available, and then accept offers from the drivers for those deliveries or rides for which each driver desired to make an offer. The bid-based delivery or passenger system must then determine which offers to accept. Conventional systems may be complicated and may not accept offers in ways that ensure delivery or encourage drivers to submit offers.

Accordingly, a need arises for techniques for assigning deliveries to drivers and for routing those deliveries that ensure delivery and encourage drivers to submit offers while also enabling scaling to include more drivers and more deliveries, and also cover deliveries over greater areas.

### SUMMARY

Embodiments of the present systems and methods may provide techniques for assigning deliveries to drivers and for routing those deliveries that ensure on time deliverability and encourage drivers to submit offers. Embodiments of the present systems and methods may provide techniques which are scalable to many drivers and many deliveries without creating overwhelming complexity. Embodiments presented here may decompose a larger problem into smaller optimization problems which may be solved simultaneously. Decomposing a large, optimization problem into a series of smaller optimization problems, which may be solved in parallel, may enable significant savings in computer resources. After solving the many smaller optimizations simultaneously, they can be recombined, re-segmented, and solved again from a different point of view. Such a process enables the solutions for assigning deliveries presented here to be scaled to much larger areas (e.g. metropolitan areas) and to many more drivers & deliveries than have been achieved previously.

For example, in an embodiment, a method for delivery routing may be implemented in a computer system comprising a processor, memory accessible by the processor, and computer program instructions stored in the memory and executable by the processor to perform the method that may comprise receiving information relating to delivery drivers' offers to deliver items in a consolidation of deliveries including at least one delivery, generating, for each delivery driver's offer, a score that indicates a desirability of that delivery driver's offer, generating, for each delivery driver's offer, a threshold time indicating a time to wait before accepting the delivery driver's offer, and matching delivery drivers with consolidations of deliveries based on maximizing a number of delivery tasks assigned to drivers and maximizing a sum of the desirability scores for the delivery drivers' offers.

In embodiments, the desirability score may be based on at least one of a time between a time a consolidation is made available and a time a delivery driver's offer is received, a distance to a first pickup location from a driver's location at a time a delivery driver's offer is received, an estimated drive distance for a consolidation, an estimated driving time for a consolidation, a driver's personal efficiency average, a creation time of a delivery task, a time a delivery task is made available, a deadline for performing a delivery task, a time a delivery driver's offer is received, a number of delivery drivers' offers on a consolidation, an age of a driver's account, a driver rating average, a number of past delivery drivers' offers made in a time period, a number of delivery tasks performed in a time period, and a number of the delivery driver's offers made in a time period since creation of a driver profile.

Generating the threshold time may comprise generating a predicted utility ratio according to a time to offer plus a predicted time to drive from a pickup location to a drop off location divided by an expected time to drive from the pickup location to the drop off location and converting the predicted utility ratio into the threshold time. Matching delivery drivers with consolidations of deliveries may comprise generating a consolidation-centric list of delivery routes based on a pickup location of a first delivery task in each consolidation, generating a driver-centric list of delivery routes based on current locations of drivers, iteratively matching a plurality of drivers with a plurality of routes using the consolidation-centric list of delivery routes and matching a plurality of drivers with a plurality of routes using the driver-centric list of delivery routes to generate a plurality of tentatively accepted delivery drivers' offers and a plurality of tentatively rejected delivery drivers' offers. Matching delivery drivers with consolidations of deliveries may further comprise finally accepting delivery drivers' offers after the threshold time has passed.

The method may further comprise calculating a metric for a route using a driver's current location, a driver's existing commitments, a location of a new delivery, a sizing of a new delivery, and a deadline for a new delivery. The method may further comprise comparing the metric with the driver's existing commitments and determining whether the route is compatible with the driver's existing commitments.

In an embodiment, the alternating consolidation-centric and driver-centric matching algorithms may be replaced with a single algorithm constructed by using an integer program. The integer program may minimize the number of offers that have to be ignored to create disjoint, size-limited matching problems. Reducing the optimal matching problem into smaller pieces may still require iteration as the initially ignored offers set aside may be reconsidered. The integer program may decompose the optimal matching problem into size-limited pieces. Examples of the size-limited pieces may include limiting the number of consolidations, limiting the number of drivers, limiting the sum of the number of consolidations and the number of drivers, or the number of offers.

In an embodiment, a system for driver assignment may comprise a processor, memory accessible by the processor, and computer program instructions stored in the memory and executable by the processor to perform receiving information relating to delivery drivers' offers to deliver items in a consolidation of deliveries including at least one delivery, generating, for each delivery driver's offer, a score that indicates a desirability of that delivery driver's offer, generating, for each delivery driver's offer, a threshold time indicating a time to wait before accepting the delivery driver's offer, and matching delivery drivers with consolidations of deliveries based on maximizing a number of delivery tasks assigned to drivers and maximizing a sum of the desirability scores for the delivery drivers' offers.

In an embodiment, a computer program product may comprise a non-transitory computer readable storage having program instructions embodied therewith, the program instructions executable by a computer, to cause the computer to perform a method that may comprise receiving information relating to delivery drivers' offers to deliver items in a consolidation of deliveries including at least one delivery, generating, for each delivery driver's offer, a score that indicates a desirability of that delivery driver's offer, generating, for each delivery driver's offer, a threshold time indicating a time to wait before accepting the delivery driver's offer, and matching delivery drivers with consolidations of deliveries based on maximizing a number of delivery tasks assigned to drivers and maximizing a sum of the desirability scores for the delivery drivers' offers.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary system in which the embodiments of the present systems and methods may be implemented.

FIGS. 2a and 2b are an exemplary flow diagram of a process of delivery offer acceptance in the system shown in FIG. 1.

FIGS. 3a and 3b are an exemplary flow diagram of a process of parallel matching within the process shown in FIGS. 2a and 2b.

FIG. 4 is an exemplary block diagram of a computer system in which processes involved in the embodiments described herein may be implemented.

### DETAILED DESCRIPTION

Embodiments of the present systems and methods may provide techniques for assigning deliveries to drivers and for routing those deliveries that ensure delivery and encourage drivers to submit offers.

Embodiments may make intelligent, near real-time decisions on which offers to accept that are predicated on the ability to know how long to wait for additional offers to arrive before issuing driver assignments. Offer scoring is the mechanism that calculates this threshold time. The goal is to balance high speed, responsive driver assignment with long cycle, slow, but optimal driver assignment. To avoid over zealously picking the first offer that arrives, embodiments may assign a threshold time to each valid offer on the order of, for example, 1-5 minutes. After this time passes, embodiments may process the offer with the parallel matching algorithm to come to a final decision on driver assignment.

Embodiments may include offer scoring with a drop-in/modular quality that allows the use of many different algorithms without changing the overall system structure. The processes may be trained at the global, market, or sender level.

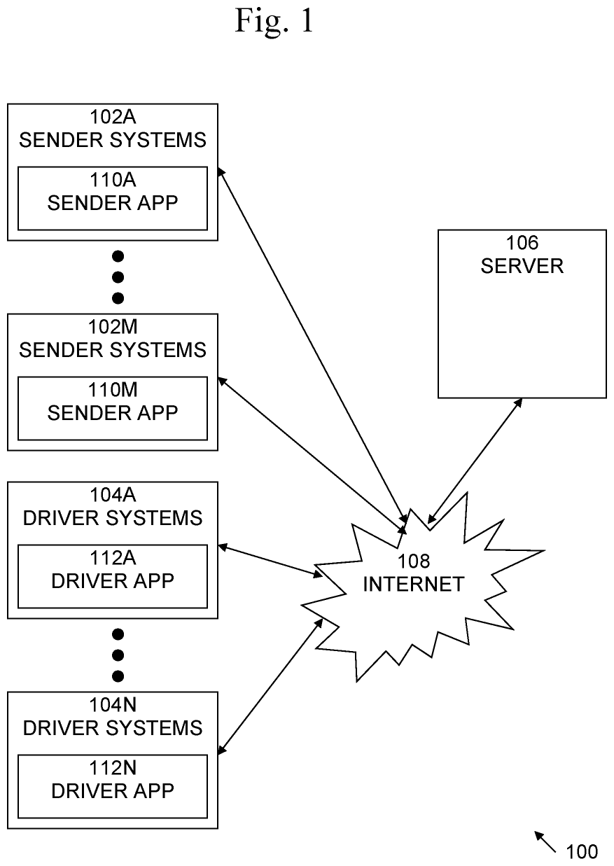

An exemplary system 100 in which embodiments of the present systems and methods may be implemented is shown in FIG. 1. In this example, system 100 may include a plurality of sender systems 102A-M, driver systems 104A-N, server 106 and a communications network, such as Internet 108. Sender systems 102A-M typically include a mobile device, such as a smartphone or tablet, but may include any computing device capable of running software programs, and may include general purpose computing devices, such as a personal computer, laptop, smartphone, tablet computer, etc., and may include special-purpose computing devices, such as embedded processors, systems on a chip, etc., that may be included in standard or proprietary devices. Sender systems 102A-M may include a sender app 110A-M, which may perform the sender functions and method steps of embodiments of the present systems and methods, as described below. Typically, a sender is a user who needs a shipment sent from a pickup location to a delivery location and utilizes a sender system, such as 102A, and a sender app, such as 110A, in order to obtain such delivery services. Sender app 110A-M may include functionality such as the shipment sender price—the price paid by the sender to send the individual shipment in question, etc.

Driver systems 104A-N typically include a mobile device, such as a smartphone or tablet, but may include any computing device capable of running software programs, and may include general purpose computing devices, such as a personal computer, laptop, smartphone, tablet computer, etc., and may include special-purpose computing devices, such as embedded processors, systems on a chip, etc., that may be included in standard or proprietary devices. Driver systems 104A-N may include a driver app 112A-N, which may perform the driver functions and method steps of embodiments of the present systems and methods, as described below. Typically, a driver is a user operating a vehicle who drives a delivery from a pickup location to a delivery location and utilizes a driver system, such as 104A, and a sender app, such as 112A, in order to obtain such delivery services. In embodiments, the present systems and methods may organize functionality in terms of a shipment having a single pickup location and a single delivery location. Driver app 104A-N may include functionality such as push notifications that may be sent to drivers announcing a potential shipment on which they may bid, an in app map of potential shipments on which drivers may bid, the shipment driver price—the price paid to the driver for delivering the individual shipment in question, driver offers—offers submitted by the driver to deliver the shipment as posted for the shipment driver price, etc. In many cases, delivery tasks may be consolidated into multi-delivery groups, known as consolidations. For example, several individual deliveries to the same building, block, general area, etc., may be grouped together to form a consolidation, and the delivery drivers then may submit offers to make all the deliveries in a consolidation. Individual deliveries may be consolidated, not just by close physical proximity, but also by overall efficiency. For instance, two items may require delivery and both delivery locations are remote, say 20 miles and 50 miles, respectively, from the pick-up location. However, if the 20-mile delivery is cheaply insertable (i.e. it is more efficient in, say, delivery time or mileage, compared with other options) into the 50-mile delivery, then these two tasks could be consolidated together, although they are not in close physical proximity. For simplicity, delivery tasks may be termed consolidations, regardless of whether the consolidation includes a plurality of delivery tasks or just one delivery task.

It is to be noted that, although in the example shown in FIG. 1, sender app 110A-M and driver app 104A-N are shown as separate apps, sender app 110A-M and driver app 104A-N may be implemented as different functions of the same app or similar apps, or in different apps, as shown.

Server 106 typically includes a plurality of server computer systems, but may include any computing device capable of running software programs, and may include general purpose computing devices, such as a personal computer, laptop, smartphone, tablet computer, etc., and may include special-purpose computing devices, such as embedded processors, systems on a chip, etc., that may be include in standard or proprietary devices. Server 106 may perform the communications, routing, scheduling, etc., functions, and method steps of embodiments of the present systems and methods, as described below. The network may include any public or proprietary communications networks, such as a telecommunications carrier network, LAN, or WAN, including, but not limited to the Internet 108.

In embodiments, offer scoring may operate on validated offers, such as those offers that have passed a series of different requirements including proximity requirements, vehicle capacity requirements, certification requirements, etc.

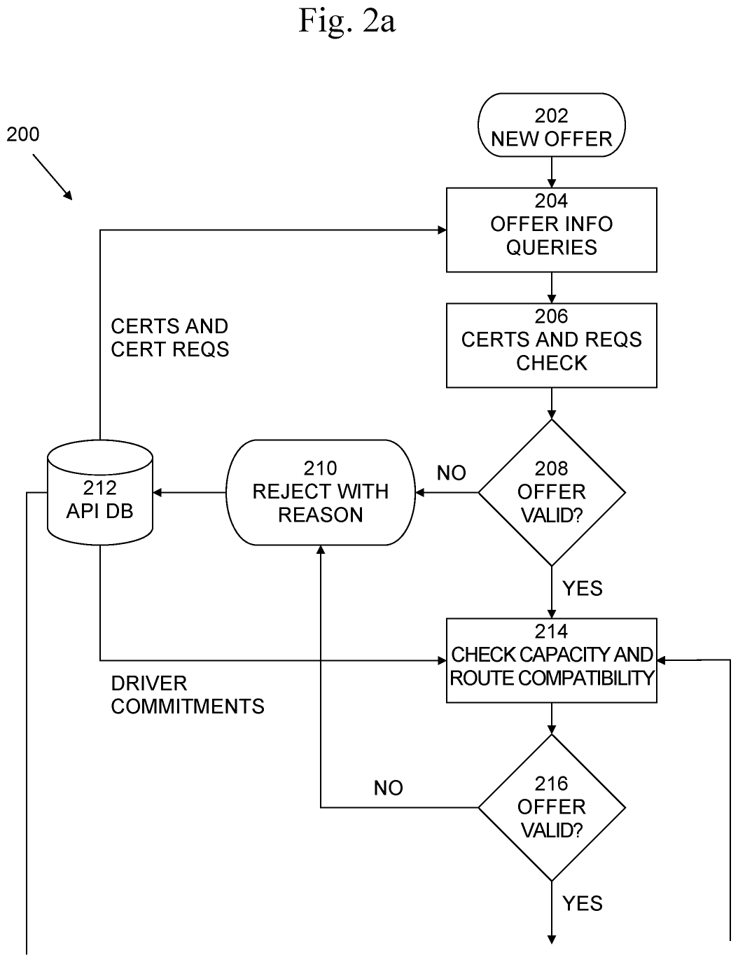

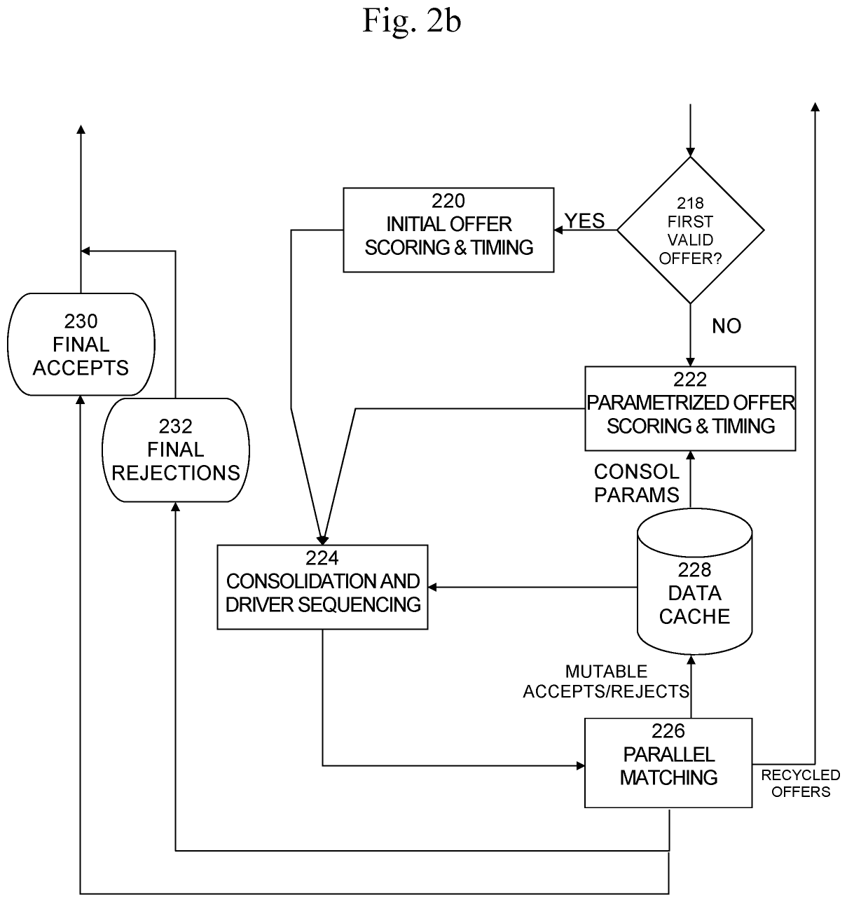

An exemplary flow diagram of a process 200 of operation of system 100 is shown in FIGS. 2a and 2b. It is best viewed in conjunction with FIG. 1. Process 200 begins with 202 in FIG. 2a, in which a driver, using a driver system, such as 104A, and a driver app, such as 112A, may submit an offer for a delivery. For example, a driver may use driver app 112A to send a delivery offer via Internet 108 to server 106. At 204, server 106 may query information relevant to delivery offer. At 206, certification and requirements checks may be performed, so as to determine the validity of the delivery offer based on factors other than driver capacity and route compatibility. At 208, it may be determined whether the delivery offer is valid based on the checks performed at 206. If a delivery offer is not valid, then at 210, the delivery offer is rejected and entered into database 212. If a delivery offer is valid, then at 214, driver capacity and route compatibility of the delivery offer is checked, for example, based on the pickup location, delivery location, delivery schedule, driver location, driver capacity, current driver assignments, etc. At 216, it may be determined whether the delivery offer is valid based on the checks performed at 214. If a delivery offer is not valid, then at 210, the delivery offer may be rejected and entered into database 212. If a delivery offer is valid, then at 218 of FIG. 2b, it may be determined whether this is the first valid offer on the route. If it is the first valid delivery offer on the route, then at 220 initial scoring and timing of the delivery offer may be performed. If it is not the first valid delivery offer on the route, then at 222 parameterized scoring and timing of the delivery offer may be performed.

Offer scoring operates on validated offers, that is, those offers that have passed a series of different requirements including proximity requirements, vehicle capacity requirements, certification requirements, etc. (206-218). Such a score may indicate a likelihood of each delivery offer being successfully performed according to all the parameters specifying the delivery. Such a score may be called a desirability score or a quality score. For example, a linear regression scoring process may be used. Features that may be used to guide the scoring process may include, for example:
Time to offer as time between the consolidation's publication time (e.g. 11:30 AM) and driver's time of offer (e.g. 11:33 AM)
Calculated distance to first pickup location from driver's location at time of offer based on haversine distance.
Estimated drive distance for the consolidation based on turn-by-turn driving directions from Google Maps API.
Estimated driving time for the consolidation based on turn-by-turn driving directions from Google Maps API.
Driver's personal efficiency average
Delivery task creation time, publication time, and deadline (e.g. 10:45 AM, 11:30 AM, 5:00 PM)
Offer creation time (e.g. 11:33 AM)
Number of offers on the consolidation
Age of driver's account in days at the time of offer
Driver rating average
Number of offers over the last [5, 7, 21, 30, 60, 90] days
Number of delivery tasks delivered over the last [5, 7, 21, 30, 60, 90] days
Number of offers in the first [5, 7, 21, 30, 60, 90] days after driver profile creation

Offer scoring may have a drop-in/modular design that allows the use of many different processes without changing the overall system structure. These processes may be trained at the global, market, or sender level. For example, factors such as driver churn analysis or likelihood to receive tips may be used when evaluating offer quality. The linear regression model may be exchanged for, for example, a neural network model, etc.

For example, these features may be oriented around the driver circumstances and based on the consolidation attributes. For instance, past delivery efficiency data may be used to identify more efficient drivers and prioritize them in a matching algorithm. Alternatively, an aggregated set of history of driver performance may be used. For each driver, a prediction of delivery efficiency for that driver based on aggregated history and the factors described above may be generated. Further, the use of time to offer as a feature helps elevate drivers who are more responsive to new opportunities in the app. Slower drivers' offers will not automatically be rejected, as capacity is another important factor incorporated into the matching algorithm.

Passing these features to a trained predictive process 220, 222 may yield an expected utilization (or utility) ratio that translates loosely to actual time taken/expected time taken. More precisely, in an aspect, the utilization ratio may be calculated as:

(time to offer+regression-predicted time to drive from pickup to drop off)/(expected time to drive from pickup to drop off).

Values for the utility ratio typically range from 1.5-3.0.

Next, the predicted utility ratio may be converted 220, 222 into threshold time calculated in minutes based on a trained model. In an embodiment, the trained model may include fitting a Gaussian to localized data using parameter estimation techniques, using the Gaussian fitting to assign a percentile rank for a utility ratio, and converting the percentile into a threshold time. The conversion of the percentile to a threshold time may comprise a linear function within a certain range or the conversion may more comprise complicated functions such as higher order polynomials, exponentials, sub-linear functions, and the like. In the case of a linear conversion function, the best percentile values may receive a near-minimum threshold time and the worst percentile values may receive a near-maximum threshold time.

As an example, assume that threshold times are being assigned between 0 and 10 minutes. If an offer is received and historical data suggests that the new offer is better than 95% of the offers expected within that geographic area, then the threshold time may be calculated using a linear function: 0+(1−95%)*(10−0)=0.5 minutes. In other words, 5% of the maximum threshold time would be assigned in this case. As another example, assuming the same linear function, if an offer is received that historical data suggests will be better than only 30% of offers received within the geographic area, then the threshold time would be 0+(1−30%)*(10−0)=7 minutes.

Not all embodiments would necessarily use a Gaussian fitting to historical data as the trained model. Other such trained models are readily apparent to those skilled in the art. Most generally, the method uses a measure of relative performance based on historical, localized offer performance in order to translate a quality score into a percentile, which is then mapped onto a threshold time based on a function. In an embodiment, this function may be monotonic, though not necessarily linear. In all cases better offers are expected to receive shorter assigned threshold times.

Put differently, the historical utility ratio distribution in a particular market may be examined as a function of historical threshold time. A threshold time may be assigned based on this distribution (e.g. ranging from ˜1-5 minutes). Additional factors other than the utility ratio may also be included in determining the threshold time, such as a prediction of the possibility of driver cancellations. Regardless of how the score is calculated, offers with threshold times may be input into the consolidation and driver sequencing step 224 of the process.

The sorting of delivery offers may be based on a subroutine that may create routes based on drivers' last known locations and a location (e.g. first pickup location) for each consolidation. The locations may comprise the latitudes and longitudes or other coordinates, as necessary. Each of these simple routes implies a sequence, and that sequence is used to create an index for sorting which may also be included when assigning groups during a parallel matching step.

For example, process 224 may use a simple insertion heuristic to build two min-cost Hamiltonian routes. Those routes may be translated directly into ordered lists. One list may be based on first pickup locations (that is, the pickup location of the first delivery task in every consolidation), with the point-to-point cost being calculated using, for example, a Haversine distance. The second list may be based on current driver locations. Both orderings may be attached to the data input to a parallel matching process 226, for example, by adding an index value to every offer, according to the sort. This index may then be an input to a parallel matching process 226, which is responsible for pairing drivers and consolidations. Thus, the delivery offer scoring may be used directly in a parallel matching process 226, to help determine what is a good offer and what is a not so good offer. Further, the delivery offer scoring may be used to determine a threshold time of how long to wait for a better offer.

Two separate sorting operations may be conducted on the list of pending offers. These offers may be based on the latitudes and longitudes of the first pickup location for each consolidation and of the driver's last known location. The offer scores and threshold times may be attached to each offer, and become useful as the matching process is completed. The scores may be useful for determining weights for the matching algorithm in 308 and 316, whereas the time thresholds may be applied in 322 to distinguish between tentative acceptances and final acceptances.

There may be a relationship or translation between the utilization rate and the scoring weights used for steps 308 and 316. In an embodiment, a relationship may be scoring weight=−1*(utilization rate)*(expected time to drive from pickup to drop off). The minus-sign may be associated with the secondary objective of finding the most optimal solution that also satisfies the primary objective of maximizing the number of deliveries that can be completed. The expected delivery time may also be minimized. In an embodiment, a relationship may be scoring weight=1/(utilization rate). However, other embodiments with different scoring algorithms may change the way that the secondary objective is calculated.

Phrased another way, the matching algorithm may optimize the following:

1) Maximize the number of deliveries that can be completed, based on the current set of valid, pending offers. This objective will be integer-valued.

2) In most cases, there will be many optimal solutions to the first objective. That is, if the highest possible delivery coverage level is N*, then there will usually exist many different subsets of the valid, pending offers that will yield N* coverage. The secondary objective seeks that subset which maintains N* coverage while maximizing the sum of quality scores.

Parallel matching process 226 may generate some delivery offers that are accepted, some delivery offers that are rejected, and some delivery offers that just go through the cycle and are neither accepted nor rejected. Delivery offers that just go through the cycle may include cases where a delivery offer has been tentatively selected, but their threshold time hasn't been hit yet, as well as cases where a delivery offer has been tentatively rejected. And so they and other delivery offers on that consolidation may be held as tentative. The tentative accepts and tentative rejects, as well as those not accepted or rejected, may be input to a data cache or redistribution storage 228 to be held for recycling. Recycling 336 may involve sending certain offers, corresponding to the remaining offers of a driver who has just had one offer accepted. It further may involve re-validating 214 the offer for factors such as vehicle capacity and on-time deliverability, and may ultimately reintroduce it to the parallel matching algorithm 226. Drivers whose delivery offers have been accepted for another delivery may also be recycled because if a driver is assigned to a route in one iteration, then that may or may not preclude that driver from being assigned to another delivery in the next cycle.

The process may iterate until finally accepted 230 or rejected 232 delivery offers are output and stored in API database 212. Information about the final acceptances 230 or rejection 232 may be output directly out of the parallel matching process 226. Otherwise, all the information goes back through the system to be filtered. Thus, in process 200, at the top information may be flowing in about new offers 202. And at the bottom, there may be the matching cycle that may be event based, rather than having a certain cadence or periods of running.

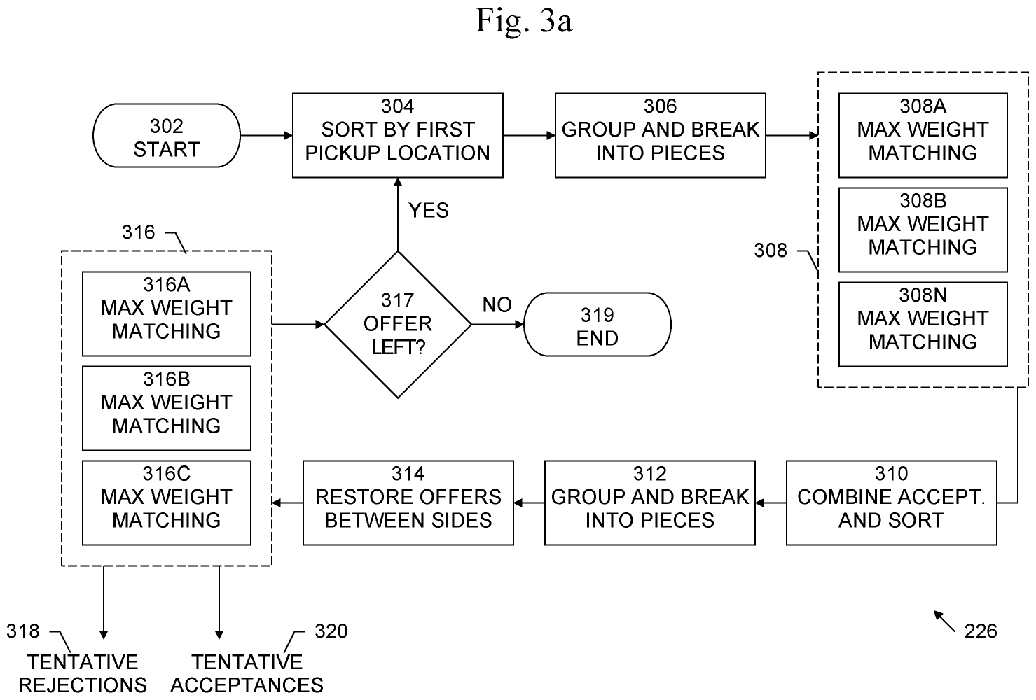

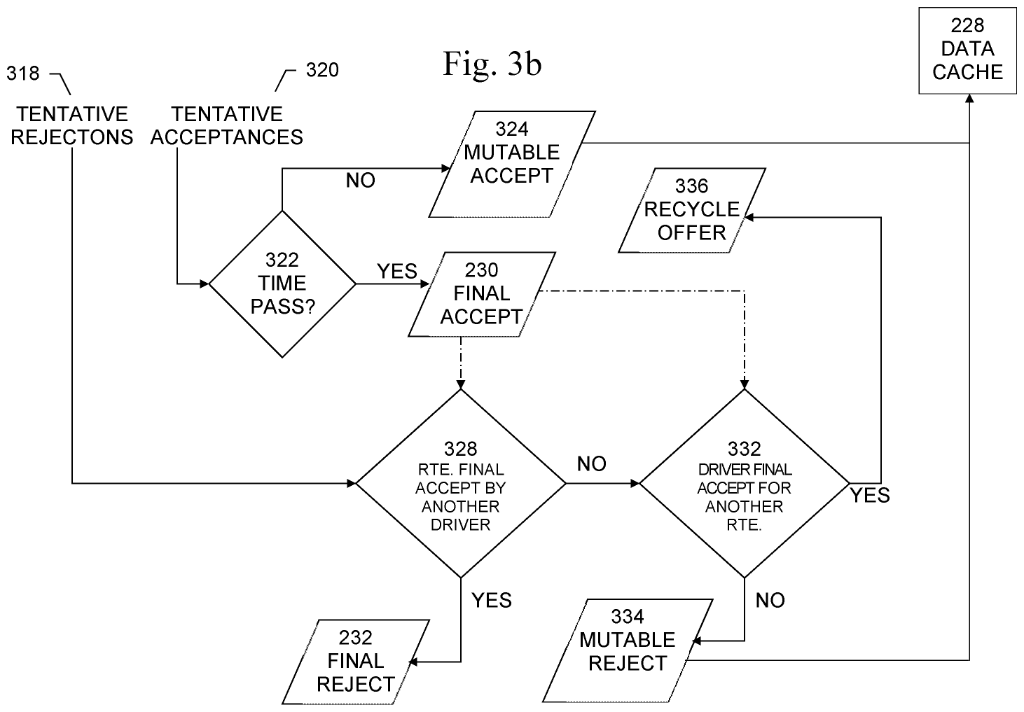

An exemplary flow diagram of a process of parallel matching 226 is shown in FIGS. 3a and 3b. The process may iterate until all offers have been either tentatively accepted or tentatively rejected. After that, rule-based logic may determine which offers should receive final acceptances or rejections, which should remain tentative, and which should be “recycled” to determine whether they are still valid and should remain under consideration.

Process 226 may begin with 302, shown in FIG. 3a, in which data of pending, valid offers, with a primary key of the offer ID may be input to process 226. Every offer has been scored by process 220 or 222 based on that offer's desirability. Process 224 may determine two different orderings of these offers, one based on first pickup locations, and one based on current driver locations. Process 226 may perform both Consolidation-Centric Matching and Driver-Centric Matching. The Consolidation-Centric Matching may begin at 304, in which the ordering based on first pickup locations may be sorted. For example, sorting may be performed based on the index that was sequenced on first pickup locations. Since the sequencing, at this step, is based on the first pickup location for each consolidation, every offer on the same consolidation will have the same index number, and will be grouped together.

At 306, the input dataframe may be broken into pieces containing equal numbers of consolidations, subject to a parameter-configurable maximum, MAX_COHORT_SIZE, including every offer on those consolidations. For example, if MAX_COHORT_SIZE=20, and offers are being considered on 50 unique consolidations, then the sorted dataframe may be broken into three dataframes—two with 17 consolidations each (and all accompanying offers), and one containing 16 consolidations. The sequencing process 224 may place the consolidation first-pickup locations close together within these chunks. This will tend to maximize conflicts among consolidations, in the sense that they will have many of the same drivers making offers on them.

At 308, a plurality of max-weight matching processes 308A-N may be run in parallel on each chunk of the sorted input dataframe. This process is good for considering offers in context; unless only one person has offered on a route, and that person has not offered on anything else, accepting that driver's offer has tradeoffs. But within the scope of each chunk of the sorted dataframe, those tradeoffs can be managed optimally. For example, that optimality may be defined with respect to two objectives—first, maximizing the number of delivery tasks covered by the solution, and second, maximizing the quality of the offers accepted (that is, the sum of the desirability scores for the selected offers).

To be clear, coverage may be treated with a higher priority than the desirability score. So, in an example, if offers on 17 consolidations are being considered, comprising 62 delivery tasks, and the optimal coverage level may be 58 delivery tasks, then the process may return the best solution, based on desirability scores, among all solutions that cover 58 delivery tasks. The integrality (i.e., the discrete, integer valuation) of the coverage objective affords us the opportunity to achieve this dual-objective optimization in one shot, if the desirability scores are normalized such that their sum will always be less than 1. To accomplish that, every offer score, can simply be replaced with

$$\frac{{s}_{i}}{1 + {\sum }_{j ∈ {C}_{i}} {s}_{j}} ,$$

where Cᵢ is the chunk of offers containing offer i. Alternatively, another expression could be used to replace every offer score, sᵢ, with

$$\frac{{s}_{i}}{1 + \vert {\sum }_{j ∈ {C}_{i}} {s}_{j} \vert} .$$

Either of these replacements ensures that higher coverage will always dominate higher offer scores, but also that the max-coverage solution with the highest desirability will be returned.

Once the solutions are computed in parallel for all of the consolidation-centric matching processes, they may be reconciled. It is possible that multiple consolidations have been assigned to the same driver (for instance, by parallel consolidation-centric matching algorithms); though the previous step prevents the same consolidation from appearing in more than one matching thread, the same driver may still appear in more than one. For drivers who are assigned to multiple consolidations by non-communicating threads, conflicts need to be resolved.

To this end, the focus should be on the offers selected at 308 to define chunks that do not share any drivers or consolidations with other chunks. Accordingly, at 310, the acceptances selected at 308 may be combined and sorted by driver location. At 312, the acceptances may be grouped by driver and broken into pieces of size, for example, MAX_COHORT_SIZE. Thus, as was done for the consolidation-centric matching, groups of drivers can be selected who were assigned to at least one consolidation, along with all consolidations assigned to those drivers. Then, at 314, the offers may be restored between each side of the resulting matching sub problems, so that, for each disjoint chunk, driver-centric max weight matching 316 may consider all offers between that chunk's driver set and consolidation set for the optimization. This has the effect not only of resolving conflicting consolidation assignments, but of considering a large variety of options for reassigning drivers. As in the consolidation-centric matching, the location-based sequencing of the drivers tends to mean that drivers whose offers conflict with one another will tend to be grouped into the same chunk. This magnifies the utility of considering all offers between a chunk's driver and consolidation sets as conflicts are eliminated.

Driver-centric max weight matching 316 then outputs a set of tentative offer rejections 318 and tentative offer acceptances 320. Thus, a single iteration of the parallel match-and-resolve process from 302-316 will produce a set of tentative offer acceptances. Among the other offers, some will not relate to tentatively accepted consolidations or drivers; while most offers will have a tentative accept/reject decision, some may require re-evaluation. Those offers can be rapidly reprocessed by the matching processes 308, 316, and the process from 302-316 may iterate until all offers receive a decision. For example, large offer sets with high levels of conflict may require around three iterations. The iterative process from 302-316 may, at first, produce tentative acceptances and rejections. They answer the question: If final, immediate decisions had to be made for every consolidation, based on the offers currently in the system, which selection is best? Given these decisions, a set of rules can be used to determine what to do with those tentative results. At 317, it may be determined whether there are any offers left after the weight matching step 316. If no offers remain, the process may end 319 with every offer being assigned to either final acceptance 230 or final rejection 232. If some offers remain, they are input to 304, for reprocessing.

Thus, as shown in FIG. 3b, at 322, it may be determined for tentative acceptances 320 whether a threshold time has passed. Each offer has a “threshold time” attached to it. This time is a function of the offer's quality score. The time is intended to modulate a willingness to wait for a better offer on a given consolidation, so, for a given consolidation, higher-scoring offers will have shorter threshold times. Each offer also has the submission time for the first valid offer on the consolidation attached to it. Tentative acceptances become final if the current time exceeds the first-offer timestamp plus the threshold time. If the first valid offer was submitted at 5:30 PM, for example, and the matching process selects an offer at 5:33 PM whose threshold time is 2.5 minutes, then that offer will be accepted officially by streaming auto-accept. At 324, offers selected by the process whose threshold time has not passed may be designated as mutable acceptances. At 230, offers selected by the process whose threshold time has passed may be designated as final acceptances.

When an offer is final-accepted, all other offers on the same consolidation must be final-rejected. Thus, at 328, the waiting tentative rejections may be checked to determine whether a route has been final accepted 230 for another driver. If so, then the tentative rejections 318 may be designated as final rejections 232. If not, then at 332, the tentative rejections 318 may be checked to determine whether a driver has been final accepted on another route. If not, the tentative rejections 318 may be designated as mutable rejections 334 which may re-enter evaluation at the data cache 228. If the driver for the tentatively rejected offer has been accepted on another route, the offer may be recycled 336, which means re-entering the process by checking capacity and compatibility 214.

Waiting for a mutably accepted offer 324 to reach its threshold time, it is possible that a tentatively rejected offer 318 will remain in the system beyond its own threshold time. However, allowing for this possibility improves the overall solution quality since it prevents the system from eliminating offers that might be selected by a subsequent run of the matching algorithm, with updated circumstances. Moreover, since the selected offers will tend to have lower threshold times, it will be more common for rejected offers to receive their final rejections sooner than their assigned threshold times. Additionally, since all offers for a given consolidation are timed against an identical first-offer time, no valid offer will reside in the system longer than a parameter-adjustable MAX_RES_TIME that is specified when threshold times are assigned to offers.

A single run of the process will assign a driver to, at most, one consolidation. However, it may be possible for a driver to serve more than one consolidation. In particular, the ability to assign “tack-on” delivery tasks should be maintained, where a driver who is already assigned to one consolidation may be considered for another delivery. With that in mind, whenever a driver is final-accepted 230 on one consolidation, that driver's remaining offers may be re-evaluated by the process 214 to determine which ones are still valid, in light of the driver's updated commitments. Those that are valid will be reintroduced to the process in short order, without resetting their first-offer or threshold times.

An offer that is not selected by the matching algorithm, whose consolidation has not been assigned to another driver for final acceptance, and whose driver has not been final-accepted on a different consolidation in the same run of the matching algorithm, may remain in the system as a tentative rejection. Tentative acceptances and tentative rejections may then be passed together, to the sequencing algorithm, where new and recycled valid offers are inserted cheaply among the tentative accepts and rejects before being passed back to the process for another run.

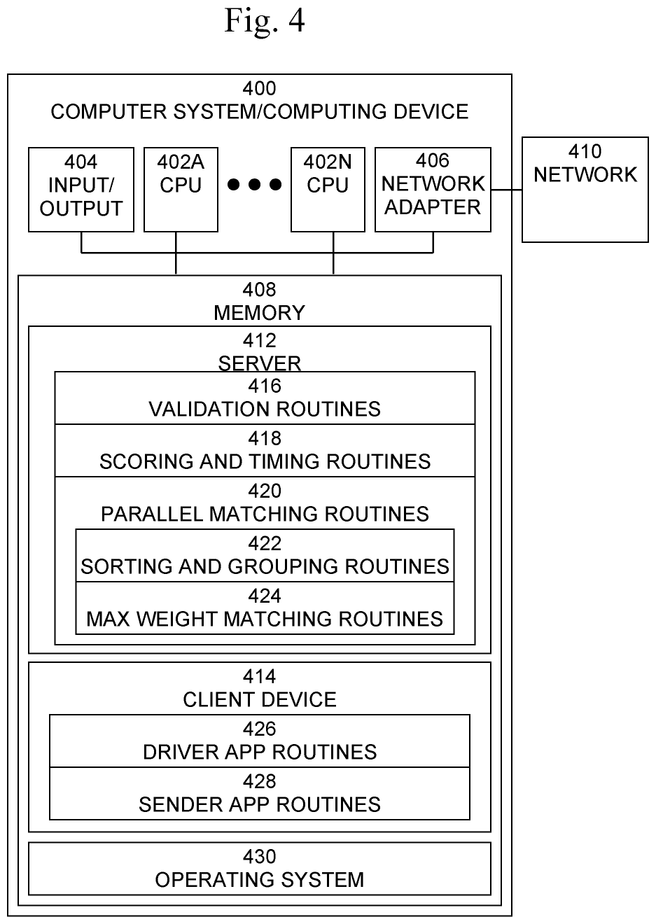

An exemplary block diagram of a computer system/computing device 400, in which processes involved in the embodiments described herein may be implemented, is shown in FIG. 4. Computer system/computing device 400 may be implemented using one or more programmed general-purpose computer systems, such as embedded processors, systems on a chip, personal computers, workstations, server systems, and minicomputers or mainframe computers, mobile devices, such as smartphones or tablets, or in distributed, networked computing environments. Computer system/computing device 400 may include one or more processors (CPUs) 402A-402N, input/output circuitry 404, network adapter 406, and memory 408. CPUs 402A-402N execute program instructions in order to carry out the functions of the present communications systems and methods. Typically, CPUs 402A-402N are one or more microprocessors, such as an INTEL CORE® processor or an ARM® processor. FIG. 4 illustrates an embodiment in which computer system/computing device 400 is implemented as a single multi-processor computer system/computing device, in which multiple processors 402A-402N share system resources, such as memory 408, input/output circuitry 404, and network adapter 406. However, the present communications systems and methods also include embodiments in which computer system/computing device 400 is implemented as a plurality of networked computer systems, which may be single-processor computer system/computing devices, multi-processor computer system/computing devices, or a mix thereof.

Input/output circuitry 404 provides the capability to input data to, or output data from, computer system/computing device 400. For example, input/output circuitry may include input devices, such as keyboards, mice, touchpads, trackballs, scanners, analog to digital converters, etc., output devices, such as video adapters, monitors, printers, biometric information acquisition devices, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system/computing device 400. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that computer system/computing device 400 is programmed to perform. In the example shown in FIG. 4, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 4, while for compactness memory 408 is shown as including memory contents for a server 412 and memory contents for a client device 414, such as a driver system or a sender system, typically computer system/computing device 400 only includes one such memory contents. In this example, server 412 may include validation routines 416, scoring and timing routines 418, parallel matching routines 420, which may include routines such as sorting and grouping routines 422, and max weight matching routines 424, and operating system 430. Likewise, in this example, client device 414 may include driver app routines 426 and sender app routines 428. Validation routines 416 may include software routines to determine the validity of the delivery offer, as described above. Scoring and timing routines 418 may include software routines to perform parameterized scoring and timing of the delivery offer, as described above. Parallel matching routines 420 may include software routines to match driver offers with delivery routes, as described above. Sorting and grouping routines 422 may include software routines to perform sorting and grouping of driver offers in Consolidation-Centric and Driver-Centric ways, as described above. Max weight matching routines 424 may include software routines to match driver offers in Consolidation-Centric and Driver-Centric ways, as described above. In this example, client device 414 may include driver app routines 426 and sender app routines 428. Driver app routines 426 may include software routines to provide push notifications, an in app map of potential shipments, etc., as described above. Sender app 428 may include software routines to perform the sender functions, as described above. Operating system 430 may provide overall system functionality.

As shown in FIG. 4, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including interpreted languages such as Python or an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for delivery assignment implemented in a computer system comprising a processor, memory accessible by the processor, and computer program instructions stored in the memory and executable by the processor to perform the method comprising:
receiving information relating to delivery drivers' offers to deliver items in a consolidation of deliveries including at least one delivery;
generating, for each delivery driver's offer, a score that indicates a desirability of that delivery driver's offer;
generating, for each delivery driver's offer, a threshold time indicating a time to wait before accepting the delivery driver's offer; and
matching delivery drivers with consolidations of deliveries based on maximizing a number of delivery tasks assigned to drivers and maximizing a sum of the desirability scores for the delivery drivers' offers.

2. The method of claim 1, wherein the desirability score is based on at least one of a time between a time a consolidation is made available and a time a delivery driver's offer is received, a distance to a first pickup location from a driver's location at a time a delivery driver's offer is received, an estimated drive distance for a consolidation, an estimated driving time for a consolidation, a driver's personal efficiency average, a creation time of a delivery task, a time a delivery task is made available, a deadline for performing a delivery task, a time a delivery driver's offer is received, a number of delivery drivers' offers on a consolidation, an age of a driver's account, a driver rating average, a number of past delivery drivers' offers made in a time period, a number of delivery tasks performed in a time period, and a number of the delivery driver's offers made in a time period since creation of a driver profile.

3. The method of claim 1, wherein generating the threshold time comprises:
generating a predicted utility ratio according to a time to offer plus a predicted time to drive from a pickup location to a drop off location divided by an expected time to drive from the pickup location to the drop off location; and
converting the predicted utility ratio into the threshold time.

4. The method of claim 1, wherein matching delivery drivers with consolidations of deliveries comprises:
generating a consolidation-centric list of delivery routes based on a pickup location of a first delivery task in each consolidation;
generating a driver-centric list of delivery routes based on current locations of drivers;
iteratively matching a plurality of drivers with a plurality of routes using the consolidation-centric list of delivery routes and matching a plurality of drivers with a plurality of routes using the driver-centric list of delivery routes to generate a plurality of tentatively accepted delivery drivers' offers and a plurality of tentatively rejected delivery drivers' offers.

5. The method of claim 1, further comprising:
calculating a metric for a route using a driver's current location, a driver's existing commitments, a location of a new delivery, a sizing of a new delivery, and a deadline for a new delivery;
comparing the metric with the driver's existing commitments; and
determining whether the route is compatible with the driver's existing commitments.

6. The method of claim 3, wherein matching delivery drivers with consolidations of deliveries further comprises:
finally accepting delivery drivers' offers after the threshold time has passed.

7. A system for delivery assignment, the system comprising a processor, memory accessible by the processor, and computer program instructions stored in the memory and executable by the processor to perform:
receiving information relating to delivery drivers' offers to deliver items in a consolidation of deliveries including at least one delivery;
generating, for each delivery driver's offer, a score that indicates a desirability of that delivery driver's offer;
generating, for each delivery driver's offer, a threshold time indicating a time to wait before accepting the delivery driver's offer; and
matching delivery drivers with consolidations of deliveries based on maximizing a number of delivery tasks assigned to drivers and maximizing a sum of the desirability scores for the delivery drivers' offers.

8. The system of claim 7, wherein the desirability score is based on at least one of a time between a time a consolidation is made available and a time a delivery driver's offer is received, a distance to a first pickup location from a driver's location at a time a delivery driver's offer is received, an estimated drive distance for a consolidation, an estimated driving time for a consolidation, a driver's personal efficiency average, a creation time of a delivery task, a time a delivery task is made available, a deadline for performing a delivery task, a time a delivery driver's offer is received, a number of delivery drivers' offers on a consolidation, an age of a driver's account, a driver rating average, a number of past delivery drivers' offers made in a time period, a number of delivery tasks performed in a time period, and a number of the delivery driver's offers made in a time period since creation of a driver profile.

9. The system of claim 7, wherein generating the threshold time comprises:
generating a predicted utility ratio according to a time to offer plus a predicted time to drive from a pickup location to a drop off location divided by an expected time to drive from the pickup location to the drop off location; and
converting the predicted utility ratio into the threshold time.

10. The system of claim 7, wherein matching delivery drivers with consolidations of deliveries comprises:
generating a consolidation-centric list of delivery routes based on a pickup location of a first delivery task in each consolidation;
generating a driver-centric list of delivery routes based on current locations of drivers;
iteratively matching a plurality of drivers with a plurality of routes using the consolidation-centric list of delivery routes and matching a plurality of drivers with a plurality of routes using the driver-centric list of delivery routes to generate a plurality of tentatively accepted delivery drivers' offers and a plurality of tentatively rejected delivery drivers' offers.

11. The method of claim 7 further comprising:
calculating a metric for a route using a driver's current location, a driver's existing commitments, a location of a new delivery, a sizing of a new delivery, and a deadline for a new delivery;
comparing the metric with the driver's existing commitments; and
determining whether the route is compatible with the driver's existing commitments.

12. The system of claim 9, wherein matching delivery drivers with consolidations of deliveries further comprises:
finally accepting delivery drivers' offers after the threshold time has passed.

13. A computer program product for delivery assignment, the computer program product comprising a non-transitory computer readable storage having program instructions embodied therewith, the program instructions executable by a computer, to cause the computer to perform a method comprising:
receiving information relating to delivery drivers' offers to deliver items in a consolidation of deliveries including at least one delivery;
generating, for each delivery driver's offer, a score that indicates a desirability of that delivery driver's offer;
generating, for each delivery driver's offer, a threshold time indicating a time to wait before accepting the delivery driver's offer; and
matching delivery drivers with consolidations of deliveries based on maximizing a number of delivery tasks assigned to drivers and maximizing a sum of the desirability scores for the delivery drivers' offers.

14. The method of claim 13, wherein the desirability score is based on at least one of a time between a time a consolidation is made available and a time a delivery driver's offer is received, a distance to a first pickup location from a driver's location at a time a delivery driver's offer is received, an estimated drive distance for a consolidation, an estimated driving time for a consolidation, a driver's personal efficiency average, a creation time of a delivery task, a time a delivery task is made available, a deadline for performing a delivery task, a time a delivery driver's offer is received, a number of delivery drivers' offers on a consolidation, an age of a driver's account, a driver rating average, a number of past delivery drivers' offers made in a time period, a number of delivery tasks performed in a time period, and a number of the delivery driver's offers made in a time period since creation of a driver profile.

15. The computer program product of claim 13, wherein generating the threshold time comprises:
generating a predicted utility ratio according to a time to offer plus a predicted time to drive from a pickup location to a drop off location divided by an expected time to drive from the pickup location to the drop off location; and
converting the predicted utility ratio into the threshold time.

16. The computer program product of claim 13, wherein matching delivery drivers with consolidations of deliveries comprises:
generating a consolidation-centric list of delivery routes based on a pickup location of a first delivery task in each consolidation;
generating a driver-centric list of delivery routes based on current locations of drivers;
iteratively matching a plurality of drivers with a plurality of routes using the consolidation-centric list of delivery routes and matching a plurality of drivers with a plurality of routes using the driver-centric list of delivery routes to generate a plurality of tentatively accepted delivery drivers' offers and a plurality of tentatively rejected delivery drivers' offers.

17. The method of claim 13 further comprising:
calculating a metric for a route using a driver's current location, a driver's existing commitments, a location of a new delivery, a sizing of a new delivery, and a deadline for a new delivery;
comparing the metric with the driver's existing commitments; and
determining whether the route is compatible with the driver's existing commitments.

18. The computer program product of claim 15, wherein matching delivery drivers with consolidations of deliveries further comprises:
finally accepting delivery drivers' offers after the threshold time has passed.
